(19) United States
(12) Patent Application Publication
(10) Pub. No.: US 2002/0053664 A1
(43) Pub. Date: May 9, 2002

(54) Rubber blockout for guard rail

(76) Inventor: Clarence R. Moore, Alabaster, AL (US)

Correspondence Address: LARSON & TAYLOR, PLC, 1199 NORTH FAIRFAX STREET, SUITE 900, ALEXANDRIA, VA, 22314, US

(21) Appl. No.: 09/885,065

(22) Filed: Jun. 21, 2001

Related U.S. Application Data
(60) Provisional application No. 60/245,924, filed on Nov. 6, 2000.

(51) Int. Cl. A01K 3/00; E01F 15/00

(52) U.S. Cl. 256/13.1

(57) ABSTRACT

A rubber blockout is provided for use in mounting a guardrail to a post. The blockout comprises natural rubber, styrene butadiene rubber and recycled tire cord with a vertical cavity formed therethrough. Optimally, the blockout comprises 50-75% recycled tire cord.

### BACKGROUND OF THE INVENTION

1. Field of the Invention

The present invention relates to a roadway safety barrier, and in particular, to a connecting element or blockout positioned between a guardrail and the posts running alongside a roadway.

2. Background of the Invention

Conventional roadway barriers typically include a metal guardrail attached to I-beam type or wooden posts placed in the ground at spaced intervals alongside a road, each with an intervening spacer, commonly known in the art as a “blockout” disposed between the guardrail and a respective post. Such an arrangement is useful in spacing the guardrail from the supporting posts to minimize the likelihood of an impact between an impinging vehicle and the posts. Direct impact of a vehicle with the posts could result in potentially serious damage to the vehicle and its occupants. When there is contact between a vehicle and the guardrail, especially in the region of the posts, the guardrail system, due to its shape and composition, will absorb the energy from the impinging vehicle. Consequently, there is minimum damage to the guardrail, allowing the entire guardrail system to retain the vehicle in the right-of-way and prevent the vehicle from entering an adjacent ditch, field, or other undesired situs.

Traditionally, blockouts are composed of metal such as steel. Recently, the U.S. Department of Transportation Federal Highway Administration has mandated that steel beam blockouts can no longer be used in guardrail systems on National Highway System roadways. The use of steel beam blockouts have been linked to vehicle rollovers subsequent to a vehicle making impact with the guardrail. Specifically, when various vehicles, strike a guardrail at the location where the guardrail meets a post with a metal blockout, the vehicle may be catapulted over the guardrail.

Several alternative materials and designs have been proposed for use as a blockout as an alternative to the conventional steel blockout. Such materials include wood and plastic and include designs which are solid, hollow or partially hollow with an internal web providing rigidity to the blockout. Presently, the Federal Highway Administration has approved various blockout designs composed of both wood and plastic as alternatives to steel blockouts. Both of these materials limit the potential for a vehicle to be catapulted over a guardrail system.

However, the currently proposed wood and plastic blockout designs have environmental and physical limitations. For example, both wood and plastic blockouts are subject to deterioration due to environmental elements such as ultraviolet rays, freezing, precipitation, salt, heat, and various chemicals such as gasoline, oil, diesel fuel, and vegetation sprays. These and other natural and artificial environmental conditions limit the applicability of these materials as alternatives for steel blockouts. Consequently, guardrail systems using wood or plastic blackouts will require the blackouts to be routinely monitored and replaced, as necessary, all leading to an increase in road maintenance costs.

### BRIEF SUMMARY OF THE INVENTION

In accordance with the general object of the present invention, a rubber blockout is provided for use in mounting a guardrail to a post.

It is another object of the present invention to provide a blockout of a material that is resistant to environmental elements such as ultraviolet rays, freezing, precipitation, salt, heat and various chemicals such as gasoline, diesel and vegetation sprays.

It is yet another object of the present invention to provide a blockout design which provides for a guardrail system that absorbs the force of an impinging vehicle whereby the guardrail system becomes elastically deformed to absorb the force of the vehicle.

These and other objectives of the present invention are achieved by providing a hollow rubber blockout comprising natural rubber, styrene butadiene and recycled tire cord. In a preferred embodiment, the rubber blockout comprises 50-75% recycled tire cord.

In a preferred embodiment, an apparatus for mounting a guardrail to a post includes a blockout comprising natural rubber, styrene butadiene rubber and recycled tire cord, with a vertical cavity formed therethrough.

In accordance with another aspect of the present invention, an apparatus is provided for mounting a guardrail to a post comprising a blockout for securing the guardrail to the post. The blockout comprises natural rubber, styrene butadiene rubber with 50-75% recycled tire cord and the blockout has a vertical cavity formed therethrough.

In accordance with yet another aspect of the present invention, a barrier system comprises a post, a guardrail, and a blockout comprising natural rubber, styrene butadiene rubber and recycled tire cord. The blockout has a vertical cavity formed therethrough, and is secured to both the guardrail and the post.

A feature of the present invention relates to the use of a hollow, rubber blockout comprising natural rubber and styrene butadiene rubber with recycled tire cord in the mounting of a guardrail to a post. An advantage of this blockout design is that the guardrail system, due to the resilient, elastic properties of the rubber blockout, along with the design of the guardrail, absorbs the force of a impinging vehicle, whereby the guardrail acts as a giant “rubber band” to redirect the vehicle back onto the roadway and not over or through the guardrail system.

An additional advantage of forming a blockout from the natural rubber, styrene butadiene, rubber and recycled tire cord composite material is that the blockout is resistant to environmental elements such as ultraviolet rays, freezing, precipitation, salt, heat and various chemicals such as gasoline, diesel and vegetation sprays.

An additional feature is the use of recycled tire cord thus providing a demand for used tires. As a result, fewer tires will be disposed of in landfills and other waste yards.

Further features and advantages of the present invention will be set forth in, or apparent from, the detailed description of preferred embodiments thereof which follow.

### BRIEF DESCRIPTION OF THE DRAWING

The invention will now be described in detail with respect to preferred embodiments with reference to the accompanying drawings, wherein:

FIG. 1 is an exploded perspective view of a guardrail system using a rubber blockout, viewed from the guardrail side, according to the present invention;

FIG. 2 is a perspective view of the guardrail system of FIG. 1 in an assembled form, viewed from the side opposite from FIG. 1 (i.e., the post side);

FIG. 3 is a perspective view of the rubber blockout of FIG. 2 looking down to the post surface side;

FIG. 4 is a sectional view of the guardrail system of FIG. 2 and taken along line 4--4 thereof; and

FIG. 5 is a perspective view of a guardrail system utilizing the rubber blockout spacer with a wooden post.

### DETAILED DESCRIPTION OF THE PREFERRED EMBODIMENTS

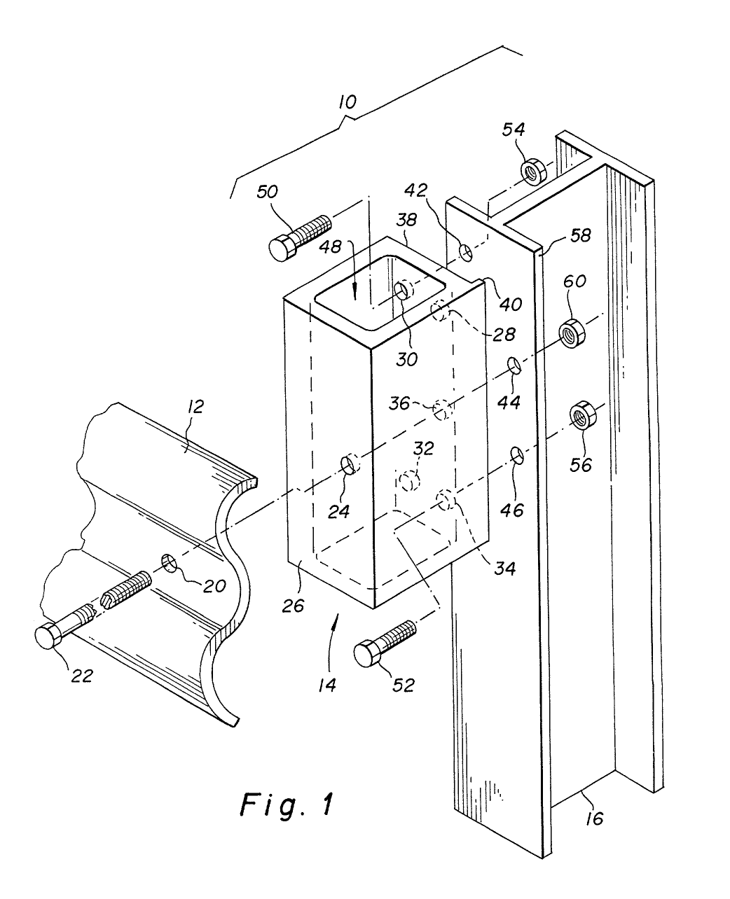

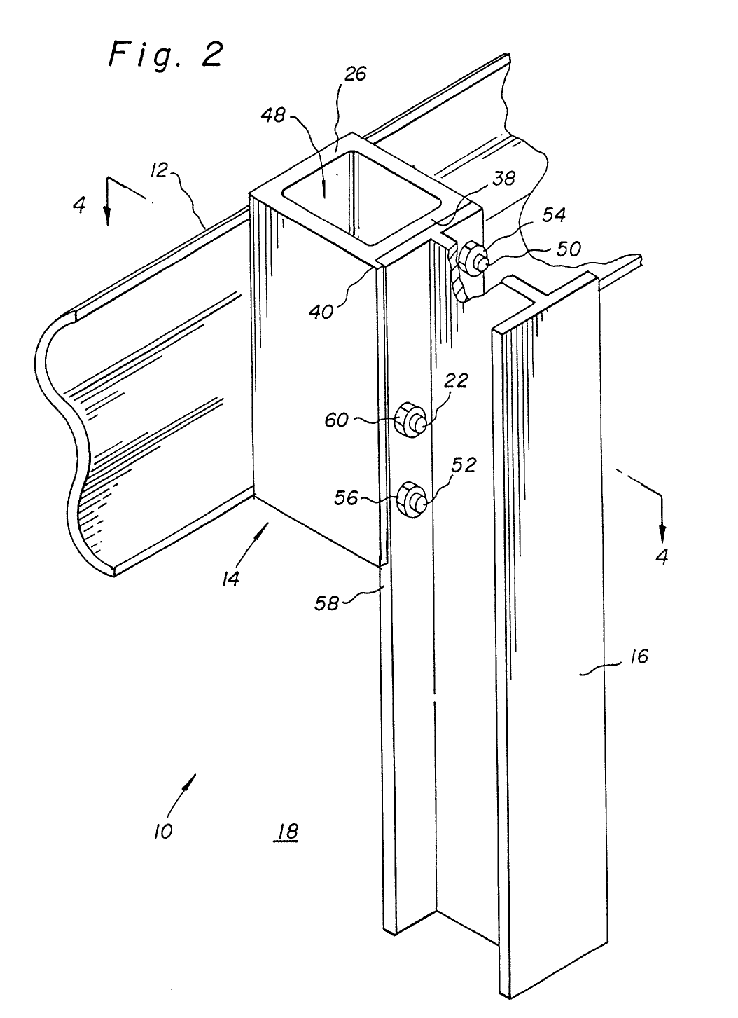

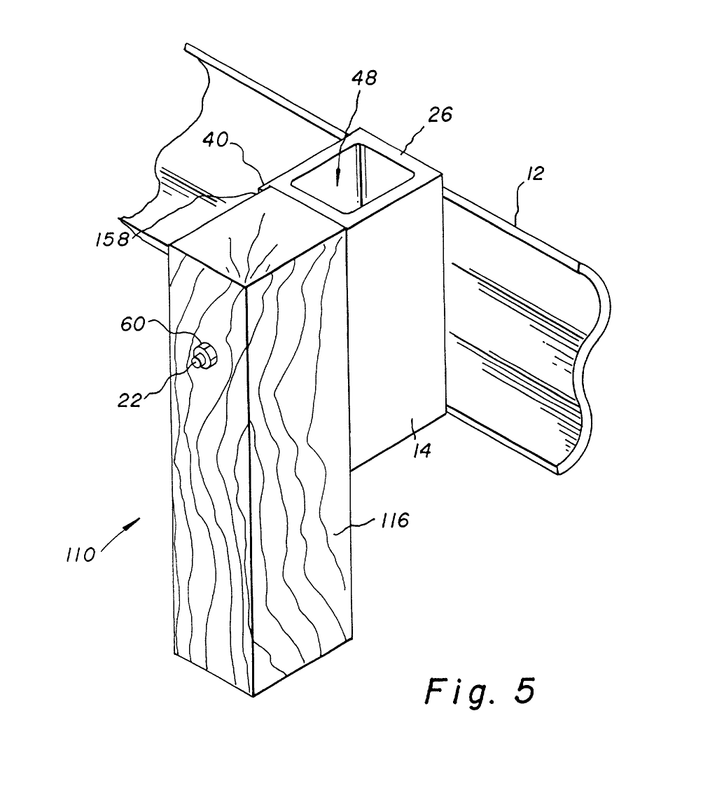

Referring now to the drawings, like numbers represent like elements throughout the several views. Reference numeral 10 generally identifies a guardrail system shown as an exploded view in FIG. 1, as an assembled view in FIG. 2, and in a sectional view in FIG. 4. The guardrail system 10 includes a generally horizontal guardrail 12, a plurality of blockouts 14, and generally vertical I-beam posts 16. The guardrail 12 is typically connected to spaced apart supporting posts 16, one of which is illustrated, having a respective number of blockouts 14 disposed between the guardrail 12 and each steel I-beam post 16.

Guardrail 12 runs generally parallel to the ground 18 and posts 16 are generally perpendicular to and partially buried into the ground 18. The guardrail 12 usually has a uniform transverse W-shaped cross-section and is usually formed of galvanized heavy gauge metal such as steel. The guardrail 12 includes a plurality of through holes 20 through which a respective bolt 22 traverses when mounting the guardrail 12 to a respective post 16.

The blockout 14 comprises natural rubber, styrene butadiene, and recycled tire cord. Preferably, the blockout 14 comprises 50-75% recycled tire cord and optimally 60% recycled tire cord. I-beam post 16 includes through holes 42, 44, 46. The natural rubber, styrene butadiene rubber and recycled tire cord composition allows the blockout 14 to be resistant to various chemicals including gasoline, diesel, and vegetation sprays. Further, the composition of the blockout 14 resists environmental elements such as ultraviolet rays, freezing, precipitation, salt, and heat. Specifically, components (i.e., compounds added by tire manufacturers during tire production) within the recycled tire cord, provide for the enhanced resistance properties of the blockout 14. The chemical composition and resulting physical properties of these compounds in combination with the natural and synthetic rubber inherently provide for the enhanced resistance properties.

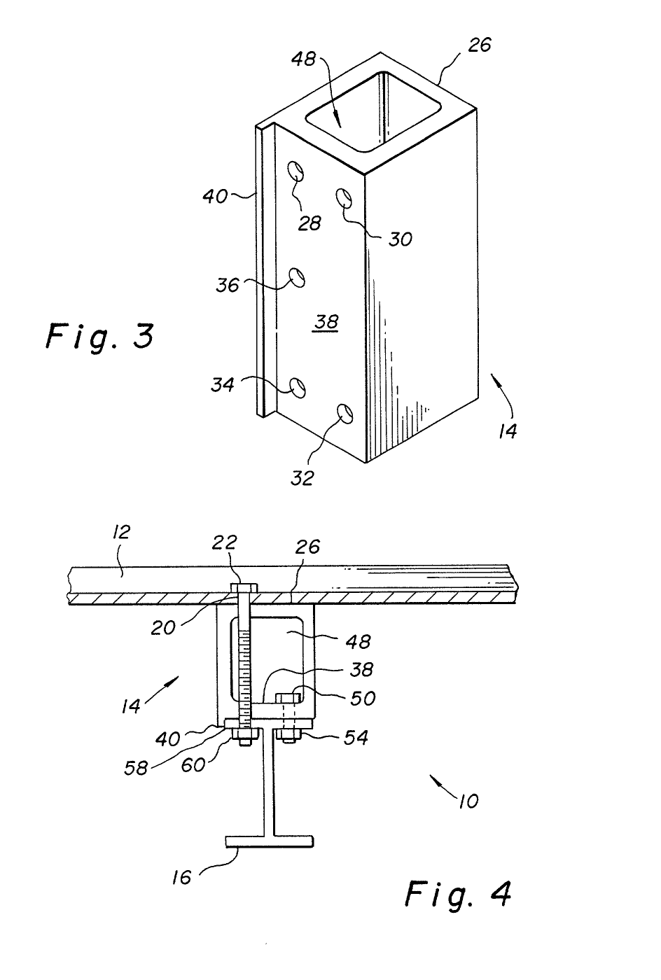

The blockout 14 includes a through hole 24 on a guardrail-facing sidewall 26. Through holes 28, 30, 32, 34, 36 traverse a post-facing sidewall 38 of the blockout 14 (best seen in FIG. 3). A protrusion 40 extends from the post-facing sidewall 38 surface, typically about ¼ of an inch and is about ⅝ of an inch wide.

The blockout 14 is formed with a vertical cavity 48 formed therethrough. The hollow shape design of the blockout 14 allows the blockout 14 to absorb the force of an errant vehicle.

Preferably, during the assembly of the guardrail system 10, the blockout 14 is first attached to the post 16 by inserting bolts through two holes which are located diagonally across the blockout. Here the bolts 50, 52 are inserted through the through holes 30, 34 of blockout 14 and through holes 42, 46 of the post, respectively. Nuts 54, 56 are then tightened down on bolts 50, 52, respectively. The protrusion 40 abuts an edge 58 of vertical flange of the post 16 when the blockout 14 is mounted to the post 16. This arrangement prevents the blockout 14 from rotating about the post 16 during the mounting of the blockout 14 to the post 16. Next, the bolt 22 is inserted through the through hole 20 of the guardrail 12, through holes 24, 36 of the blockout 14 and through hole 44 of the post 16. A nut 60 is then tightened down on the end of bolt 22.

The plurality of through holes 24, 28, 30, 32, 34, 36 of blockout 14, allows the blockout 14 to be mounted and used in a variety guardrail/post systems. For example, blockout 14 can be rotated 180° about line 4--4 to be used for mounting to a post having an inverse through hole pattern to that of post 16, i.e., a post 16 with the two holes on the opposite side of the beam. In addition, if the post has additional through holes that compliment that of the blockout 14, additional bolts and nuts may be used to secure the blockout 14 to the post.

While it is preferable to use diagonal through holes (e.g., through holes 28 and 32, or 30 and 34), any of a number of bolting patterns may be used in mounting the blockout 14 to the post 16. For example, in an alternative form, a single bolt, namely bolt 22 may be used to mount the guardrail 12 to the post 16 with the blockout 14 without an aid of bolts 50, 52.

As should now be apparent to one of ordinary skill in the art, the plurality of through holes, e.g., 24, 28, 30, 32, 34, 36, are provided to accommodate conventional guardrail and posts currently in use on roadways. In addition to the through hole pattern described and depicted herein with reference to the blockout 14, the through hole pattern can be modified to accommodate further guardrail systems. For example, additional through holes may be made in the blockout 14 to align with the through holes of various other posts.

Referring now to FIG. 5, in an alternative embodiment, a guardrail system 110 comprises a wooden post 116 rather than the steel I-beam post 16. A single bolt, bolt 22, is used to fasten each post 116 to the guardrail 12. The blockout 14 is mounted between the post 116 and the guardrail 12 with the protrusion 40 abutting a vertical edge 158 of the post 116 in a similar manner as described above with reference to guardrail system 10.

Guardrail systems 10, 110 (i.e., the guardrail 12, blockout 14 and posts 16, 116) provide a road barrier system which absorbs the force, i.e., the energy, from an errant, impinging vehicle. The guardrail systems 10, 110 act like a giant “rubber band” to absorb the force of the impinging vehicle. The resilience of the guardrail systems 10, 110 is provided by the elastic, shock absorbing properties of the blockout 14 which stretches and then contracts, as it absorbs and redirects the force to redirect the impinging vehicle back onto the roadway. And, unlike conventional blockout designs, the rubber composition of the blockout 14 provides an elastic, resilient blockout that is resistant to environmental elements such as ultraviolet rays, precipitation, salt, heat and various chemicals such as gasoline, diesel and vegetation sprays due to additives present in the recycled tire cord material.

It will be apparent to one of ordinary skill in the art that any desirable dimensioned blockout may be formed to accommodate various guardrail and post systems. These variations include, but are not limited to, varying the thickness of the sidewalls, the length, width and height of the blockout and the arrangement of through holes. While depicted as having generally orthogonal, planar sidewalls, the sidewalls may be dimensioned to accommodate the surfaces of the guardrail 12, posts 16, 116 or to provide desirable properties when employed in a guardrail system.

Although the invention has been described in detail with respect to preferred embodiments thereof, it will be apparent to one skilled in the art that the invention is capable of numerous modifications and variations, within the spirit and scope of the invention.

What is claimed is:

1. A blockout for use in mounting a guardrail to a post, said blockout comprising natural rubber, styrene butadiene rubber, and recycled tire cord, and having a vertical cavity formed therethrough, for mounting the guardrail to the post.

2. The blockout of claim 1, wherein said recycled tire cord comprises 50 to 75 percent, by weight, of said blockout.

3. The blockout of claim 1, wherein said recycled tire cord comprises 60 percent, by weight, of said blockout.

4. The blockout of claim 1, further comprises a protrusion extending from a vertical edge of said blockout for abutting a vertical edge of the post when said blockout is mounted to the post.

5. The blockout of claim 4, wherein said protrusion is shaped to prevent said blockout from rotating about the post.

6. The blockout of claim 1, further comprising a plurality of through holes for mounting hardware to traverse when mounting said blockout to the guardrail and the post.

7. The blockout of claim 1, further comprising at least one bolt traversing at least one of said plurality of through holes.

8. The blockout of claim 1, wherein said blockout comprises substantially orthogonal sidewalls.

9. A blockout for mounting a guardrail to a post, said blockout comprising natural rubber, styrene butadiene rubber with 50 to 75 percent recycled tire cord, said blockout having a vertical cavity formed therethrough.

10. The blockout of claim 9, wherein said recycled tire cord comprises 60 percent, by weight, of said blockout.

11. The blockout of claim 9, further comprising a protrusion extending from a vertical edge of said spacer for abutting a vertical edge of the post when said blockout is mounted to the post.

12. The blockout of claim 11, wherein said protrusion is shaped to prevent said blockout from rotating about the post.

13. The blockout of claim 9 further comprising a plurality of through holes for mounting hardware to traverse when mounting said blockout to the guardrail and the post.

14. The blockout of claim 9, further comprising substantially orthogonal sidewalls.

15. A barrier system comprising:
a post;
a guardrail; and
a blockout comprising natural rubber, styrene butadiene rubber and recycled tire cord and having a vertical cavity formed therethrough, disposed between, and secured to said guardrail and said post.

16. The barrier system of claim 15, wherein said blockout further comprises 50 to 75 percent recycled tire cord.

17. The apparatus of claim 16, wherein said recycled tire cord comprises 60 percent, by weight, of said blockout.

18. The apparatus of claim 15, wherein said blockout has a protrusion extending from a vertical edge of said spacer for abutting a vertical edge of said post when said blockout is mounted to said post.

19. The apparatus of claim 18, wherein said protrusion is shaped to prevent said blockout from rotating about said post.

20. The apparatus of claim 15, wherein said blockout comprises a plurality of through holes for mounting hardware to traverse when mounting said blockout to said guardrail and said post.

21. The apparatus of claim 15, wherein said blockout comprises substantially orthogonal sidewalls.
